(19) United States
(12) Patent Application Publication
(10) Pub. No.: US 2014/0325330 A1
(43) Pub. Date: Oct. 30, 2014

(54) Pedagogical System and Method

(71) Applicant: Assignment Angels Pty Ltd, Brisbane (AU)

(72) Inventors: Selina Joy Tomasich, Mooloohba (AU); Lee-anne Maree Bye, Brisbane (AU); Diana Jasmine Gay, Brisbane (AU)

(21) Appl. No.: 14/360,216

(22) PCT Filed: Nov. 12, 2012
(86) PCT No.: PCT/AU2012/001437

§ 371 Date: May 22, 2014

(30) Foreign Application Priority Data
Nov. 25, 2011 (AU) 2011904921

(51) Int. Cl. G06F 17/24

(52) U.S. Cl. CPC G06F 17/243
USPC 715/222

(57) ABSTRACT

A pedagogical system and method enables improved writing skills by assisting in the generation of a document. The system includes a server having a data interface for receiving a question to be answered in the document. A data store associated with the server includes a plurality of directive words and descriptive text associated with each of the directive words. The server also includes a processor and associated memory, including program code for identifying directive words in the question and retrieving, from the data store, descriptive text associated with the directive words. An output interface then displays the descriptive text for each of the directive words.

### FIELD OF THE INVENTION

The present invention relates to a pedagogical system and method. In particular, although not exclusively, the invention relates to a pedagogical system and method for improving writing skills.

### BACKGROUND TO THE INVENTION

Essay and report writing is very important in most areas of education. In high school and university, for example, essays and reports are often the primary work products that determine a student's performance. Efficient communication skills, including writing skills, are also very important later in life.

The importance of effective writing is also illustrated through a relatively common problem, namely when students acquire sufficient knowledge in their area of study but are unable to clearly communicate their knowledge. Students frequently have difficulties relating to the organisation of thoughts, addressing assignment criteria, structuring information, and referencing, for example.

The presence of one or more of these difficulties often means that students, despite having researched well and engaged in critical thinking, do not achieve grades that correspond to their skill or knowledge of a topic. This lack of understanding of the writing process and the underdevelopment of writing skills often means that students lose both marks and confidence. Some students even drop out of university study primarily because they could not quickly develop the critical skill of writing.

Courses often are used to help develop a student's writing skills. These courses may include classes on writing, and the study of textbooks. Such classes often focus on the theory behind essay writing, as actual essay writing may not be practical due to time constraints.

However, a problem with such courses is that they do not work well with all students. Some students may have difficulty learning when attending a course or, simply reading about writing, rather than actually writing.

The prior art includes assignment or essay generation tools that can help develop a student's writing skills. For example, such assignment generation tools may generate an assignment or essay, or part thereof, from a topic or question. The text generation may include a manual step, where a third party manually adds text, or may include automatic generation of text from a database or similar tool. The student may then modify the text as needed.

A problem with such prior art assignment or essay generation tools is that at least part of the assignment text is generated, rather than written by the student. As the text is not written by the student, such tools may have limited use in an academic context, for example, as the text is not that of the student.

A second problem with prior art assignment or essay generation tools is that they may not actually help a student learn to structure an assignment or essay, as the text is generated by the tool rather than by the student. As discussed above, some students may have difficulty learning when they are not actually writing parts of the assignment.

Templates are another example of a tool that may be used to help develop a student's writing skills. Templates may include a prefilled assignment or essay on an example topic, which students are to modify in order to create their own assignment or essay.

A problem with such templates is that they do not necessarily help a student learn to structure an assignment or essay. To some students, following a template is similar to reading another person's essay or assignment. Although a student may appreciate that another person's assignment is well written, the student may not be able to learn to structure an essay by simply reading the other person's assignment.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

According to one aspect, the invention resides in a method for assisting in the generation of a document, the method including:

receiving, on a data interface, a question or instruction relating to the document;

identifying, by a computer processor, at least one directive word in the question or instruction;

retrieving, from a data store, descriptive text associated with the at least one directive word;

receiving, on a data interface, a plurality of main points to be addressed in the document;

receiving, on a data interface, a target word count for the document;

assigning, by a computer processor, a target word count for each of the plurality of main points based at least partly on the target word count for the document and the number of main points in the plurality of main points; and

generating, by a computer processor, a user interface including:
a plurality of document generation assistant components, wherein a first component of the plurality of document generation assistant components includes descriptive text for the at least one directive word and a second component of the plurality of document generation assistant components includes the target word counts for each of the plurality of main points; and
an input field for each of the plurality of main points;
wherein; upon presentation of the user interface, the plurality of main points to be addressed is presented in association with text input fields for the plurality of main points, and the second component is presented in association with text input fields for the plurality of main points.

Preferably, the method further includes:

receiving, on a data interface and via the text input fields for the plurality of main points, text relating to the plurality of main points; and

generating, by a computer processor, at least part of the document based upon the text relating to the plurality of main points.

Preferably, the method further includes:

receiving, on a data interface and via a text input field for an introduction, text relating to an introduction of the document; and

receiving, on a data interface and via a text input field for a conclusion, text relating to a conclusion of the document; and

generating, by a computer processor, at least part of the document based upon the text relating to the introduction and conclusion of the document,

wherein the user interface includes:
the input field for the introduction; and
the input field for the conclusion.

Preferably, the method further includes:

receiving, on a data interface and from a text input field, text for the document, wherein the text is associated with a main point of the plurality of main points, the introduction or the conclusion; and

determining, by a processor, a number of words in the text;

wherein, upon presentation of the user interface, the number of words in the text is presented in association with the text input field.

Preferably, the user interface further includes:

at least one brainstorming text input field,

wherein, upon presentation of the user interface, the at least one brainstorming text input field is presented before the text input field for each of the plurality of main points.

Preferably, the text input field for the introduction includes a thesis statement text input component, and upon presentation of the user interface, any text input in the thesis statement text input component is presented in association with the input fields for the plurality of main points.

Preferably, the user interface includes a reference element including:

a reference type selection field;

a plurality of text input fields; and

information relating to referencing;

wherein, upon presentation of the user interface, the information relating to referencing is selected and presented based upon selection in the reference type selection field.

Preferably, the user interface comprises a HyperText Markup Language document.

According to another aspect, the invention resides in a system for assisting in the generation of a document, the system including:

a server including:
a data interface, for receiving a question to be answered in the document;
a data store, including a plurality of directive words and descriptive text associated with each of the directive words;
a processor and memory including program code, for:
   identifying directive words in the question;
   retrieving, from the data store, descriptive text associated with the directive words; and
an output interface, for displaying the descriptive text for each of the directive words.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 diagrammatically illustrates a pedagogical system, according to an embodiment of the present invention;

FIG. 2 diagrammatically illustrates a server of the pedagogical system of FIG. 1, according to an embodiment of the present invention;

FIG. 3 illustrates a planning and structure component of the pedagogical system of FIG. 1, according to an embodiment of the present invention;

FIG. 4 illustrates a question analysis component of the pedagogical system of FIG. 1, according to an embodiment of the present invention;

FIG. 5 illustrates a brainstorming component of the pedagogical system of FIG. 1, according to an embodiment of the present invention;

FIG. 6 illustrates a structuring component of the pedagogical system of FIG. 1, according to an embodiment of the present invention;

FIG. 7 illustrates an introduction writing component of the pedagogical system of FIG. 1, according to an embodiment of the present invention;

FIG. 8 illustrates a main points writing component of the pedagogical system of FIG. 1, according to an embodiment of the present invention;

FIG. 9 illustrates an essay information component of the pedagogical system of FIG. 1, according to an embodiment of the present invention.

FIG. 10 illustrates a reference component of the pedagogical system of FIG. 1, according to an embodiment of the present invention.

FIG. 11 illustrates an essay completion component of the pedagogical system of FIG. 1, according to an embodiment of the present invention;

FIG. 12 illustrates a user interface according to an embodiment of the present invention; and

FIG. 13 illustrates a method for assisting in the generation of a document, according to an embodiment of the present invention.

Those skilled in the art will appreciate that minor deviations from the layout of components as illustrated in the drawings will not detract from the proper functioning of the disclosed embodiments of the present invention.

### DETAILED DESCRIPTION OF THE INVENTION

Embodiments of the present invention comprise pedagogical systems and methods. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the invention resides in a method for assisting in the generation of a document, the method including: receiving, on a data interface, a question relating to the document; identifying, by a computer processor, at least one directive word in the question; retrieving, from a data store, descriptive text associated with the at least one directive word; and presenting, on a data interface, the descriptive text for the at least one directive word.

Advantages of some embodiments of the present invention include providing an improvement in writing skills while writing a report or document, assistance in breaking a writing task into smaller tasks, assistance in understanding the problem or question of the writing task, assistance in providing strong and convincing arguments and evidence, and improved formalities such as referencing.

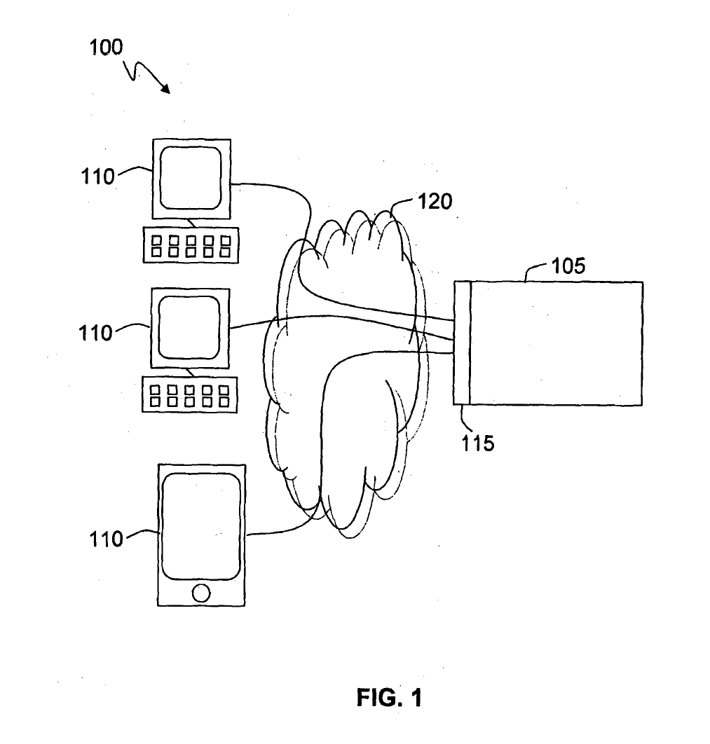

FIG. 1 diagrammatically illustrates a pedagogical system 100, according to an embodiment of the present invention.

The pedagogical system 100 includes a centralized server 105 and a plurality of devices 110 connected to the server. The plurality of devices 110 may include a computer, a tablet computer and a smartphone, for example.

The pedagogical system 100 includes a web interface 115 which is used by the plurality of devices 110 to access the server 105 through a network 120 such as the Internet.

The system enables students, for example, to write and access essays using different devices 110, through the server 105.

Although the term essay is used throughout this specification, the invention is applicable to any type of written work including, but not limited to essays, reports, assignments, written examinations, and documentation. Similarly, the written work may be academic or non-academic.

As further described below, the pedagogical system 100 aids in writing an essay in three main stages. A user may step back and forward between the stages, or follow them sequentially.

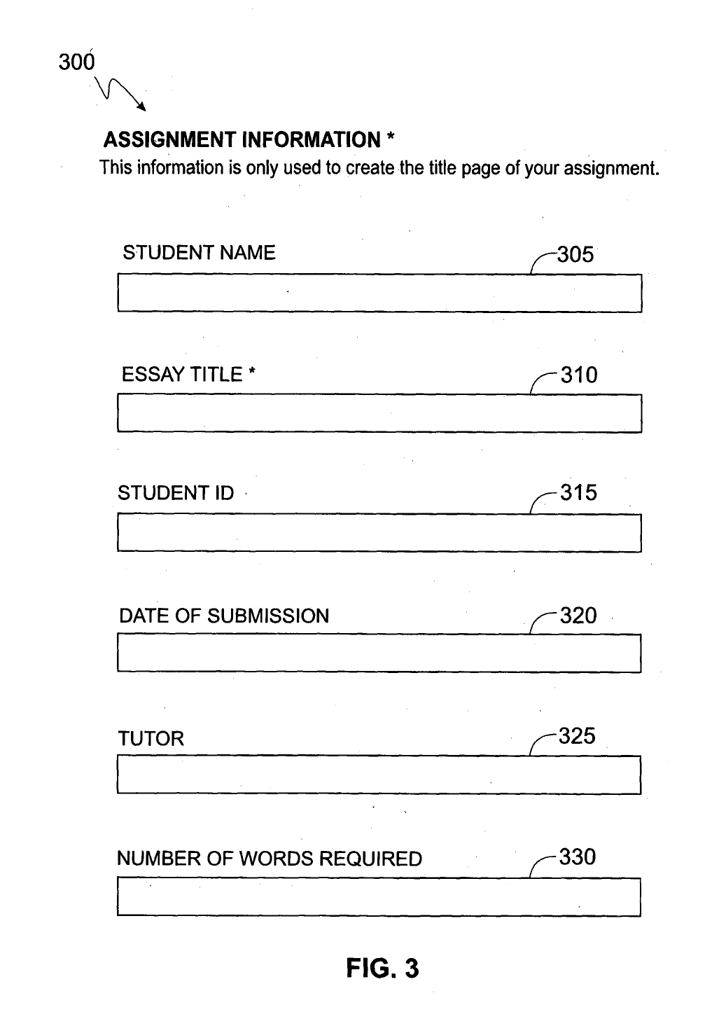

The first stage relates to planning, and includes understanding the essay question, brainstorming for ideas, and developing a strong structure. Components of the first stage are illustrated in FIGS. 3-6.

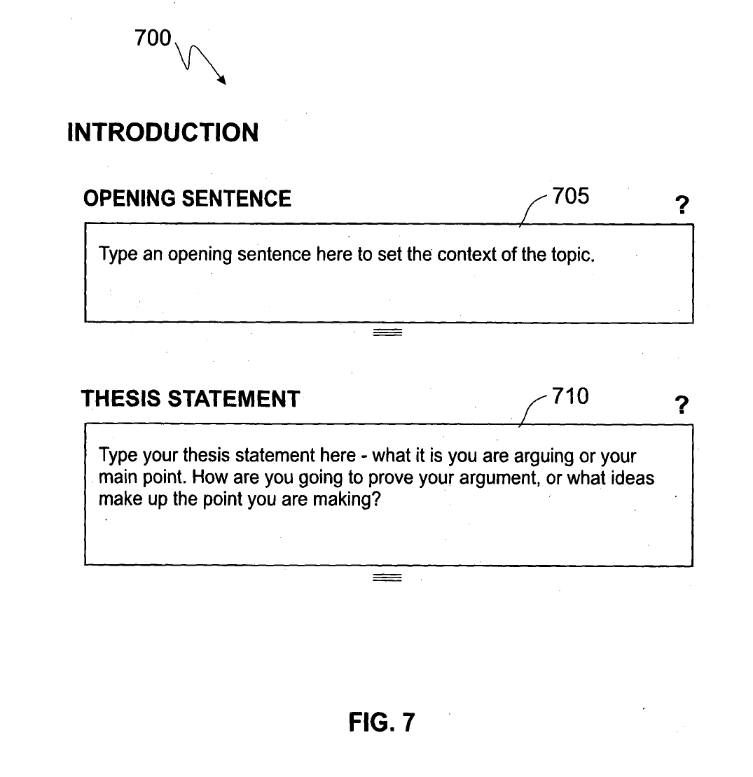

The second stage involves writing the essay. The planning from the first stage assists the user in writing the essay. The second stage includes help in writing introductions, use of the thesis statement defined in the first stage, use of topic sentences, help in writing conclusions, and assistance in the use of strong arguments and evidence to convince the reader. Components of the second stage are illustrated in FIGS. 7-10.

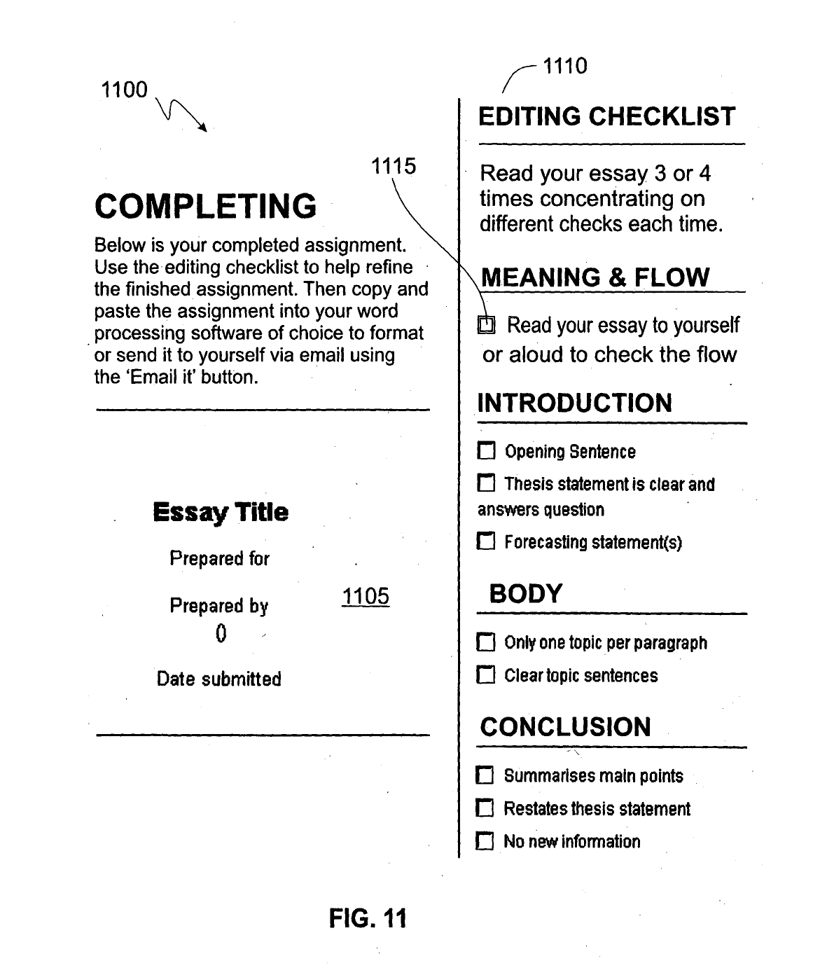

The third stage is where a user checks their work to uncover and correct errors. A component of the third stage is illustrated in FIG. 11.

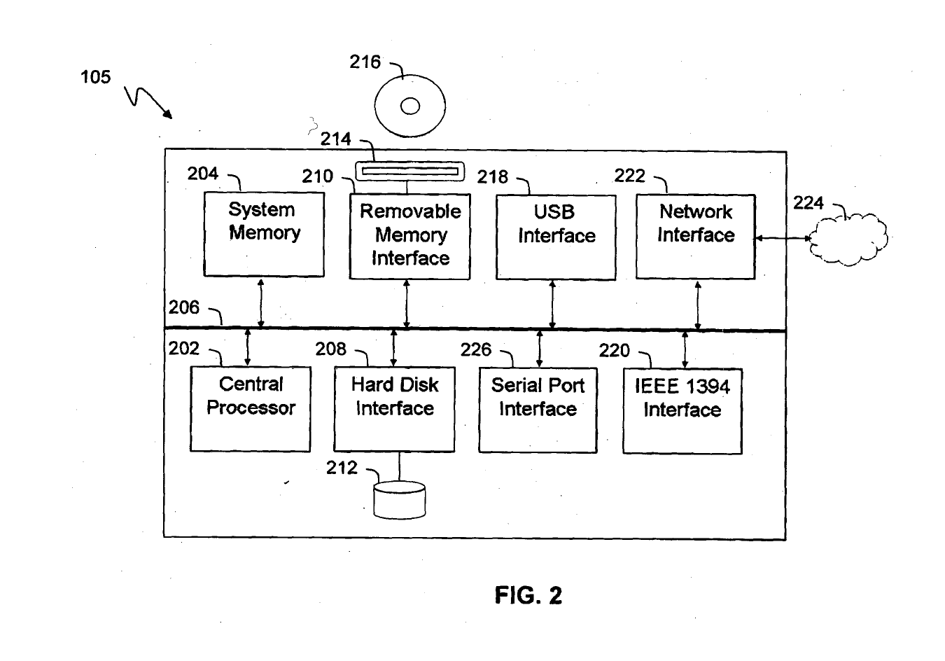

FIG. 2 diagrammatically illustrates a server 105, according to an embodiment of the present invention.

The server 105 includes a central processor 202, a system memory 204 and a system bus 206 that couples various system components, including coupling the system memory 204 to the central processor 202. The system bus 206 may be any of several types of bus structures including a memory bus or memory controller, a peripheral bus, and a local bus using any of a variety of bus architectures. The structure of system memory 204 is well known to those skilled in the art and may include a basic input/output system (BIOS) stored in a read only memory (ROM) and one or more program modules such as operating systems, application programs and program data stored in random access memory (RAM).

The server 105 may also include a variety of interface units and drives for reading and writing data. In particular, the server 105 includes a hard disk interface 208 and a removable memory interface 210, respectively coupling a hard disk drive 212 and a removable memory drive 214 to the system bus 206. Examples of removable memory drives 214 include magnetic disk drives and optical disk drives. The drives and their associated computer-readable media, such as a Digital Versatile Disc (DVD) 216 provide non-volatile storage of computer readable instructions, data structures, program modules and other data for the computer system 200. A single hard disk drive 212 and a single removable memory drive 214 are shown for illustration purposes only and with the understanding that the server 105 may include several similar drives. Furthermore, the server 105 may include drives for interfacing with other types of computer readable media.

The server 105 may include additional interfaces for connecting devices to the system bus 206. FIG. 2 shows a universal serial bus (USB) interface 218 which may be used to couple a device to the system bus 206. For example, an IEEE 1394 interface 220 may be used to couple additional devices to the server 105.

The server 105 can operate in a networked environment using logical connections to one or more remote computers or other devices, such as a server, a router, a network personal computer, a peer device or other common network node, a wireless telephone or wireless personal digital assistant. The server 105 includes a network interface 222 that couples the system bus 206 to a local area network (LAN) 224. Networking environments are commonplace in offices, enterprise-wide computer networks and home computer systems.

A wide area network (WAN), such as the Internet, can also be accessed by the server 105, for example via a modem unit connected to a serial port interface 226 or via the LAN 224.

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the server 105 can be operated in a client-server configuration to permit a user to retrieve web pages from a web-based server. Furthermore, any of various conventional web browsers can be used to display and manipulate data on web pages.

The operation of the server 105 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCs, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

The server 105 includes a web interface through which a plurality of components is made available. The components advantageously comprise HTML and a scripting language such as JavaScript, and are used to receive and transmit data via the data interfaces. The components are described in further detail below with reference to FIGS. 3-12.

Based upon data received through the web interface and/or components below, at least part of the document or essay is generated. The generation of the document advantageously includes application of the data to a predefined template.

The system 100 may include multiple predefined templates, such as an essay template, a report template, or even multiple versions of each category of template. Each template may include different layout characteristics, such as font, but may also include different structural elements that are used in the generation of the document. For example, a template may include automatic section numbering or automatic generation of text.

According to an embodiment, the generation of the document includes automatic generation of an executive summary and a table of contents. The executive summary may be generated based upon main topic data as entered by the user (discussed in further detail below), for example. The table of contents may be generated based upon an automatic section numbering, or the main topic data as entered by the user, for example.

The server 105 includes a plurality of user accounts, which are used to provide access control. In addition to access control, each user account may be associated with a data repository, which is used to store previous essays.

FIG. 3 illustrates a planning and structure component 300 of the pedagogical system 100. The planning and structure component 300 is used to obtain information regarding an assignment, such as an essay, from the user.

The planning and structure component 300 includes a name field 305, which is used to enter the user's name, as presented in the essay, a title field 310, which is used to enter the title of the essay, a identifier field 315, which is used to enter a student ID number or similar identification, a date field 320, which is used to enter the submission date, a tutor field 325, which is used to enter the name of the tutor, and a number of words field 330, which is used to enter the maximum number of words for the essay.

The data entered through fields 305-330 is used to generate a title page of the essay. This is advantageously performed using a predefined template, but as would readily be understood by a skilled reader, a user defined or dynamic template may be used.

The submission date data entered in field 320 may indicate a due date, which is then used by the pedagogical system 100 to provide reminders to the user, or otherwise assist the user in time planning.

The maximum number of words entered in date field 330 is used by the system to assist in monitoring the progress of the essay, and to aid in planning of the essay. This is described in further detail below.

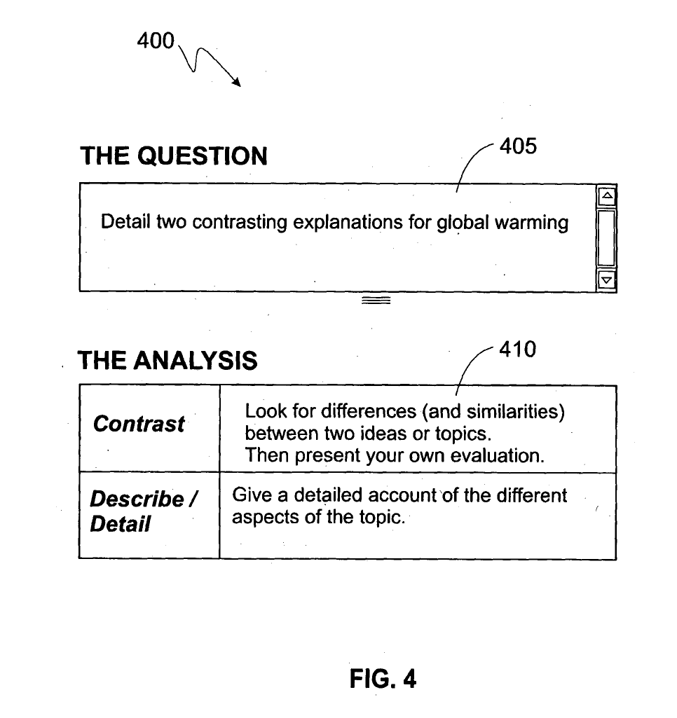

FIG. 4 illustrates a question analysis component 400 of the pedagogical system 100.

The question analysis component 400 includes a question input field 405. The question input field 405 is used by the user to input the question to be answered or addressed by the essay.

The pedagogical system 100 analyses the question. The analysis is performed by identifying content words, limiting words, and directive words. For each of the identified words, a definition or clarification of the word is retrieved, preferably from a specific database of words.

Each identified word of the question is then presented in an analysis section 410, together with the definition or clarification.

The analysis performed and presented in the analysis section assists the user in understanding the question to be answered at an early stage, thus reducing the amount of time wasted on off-topic work.

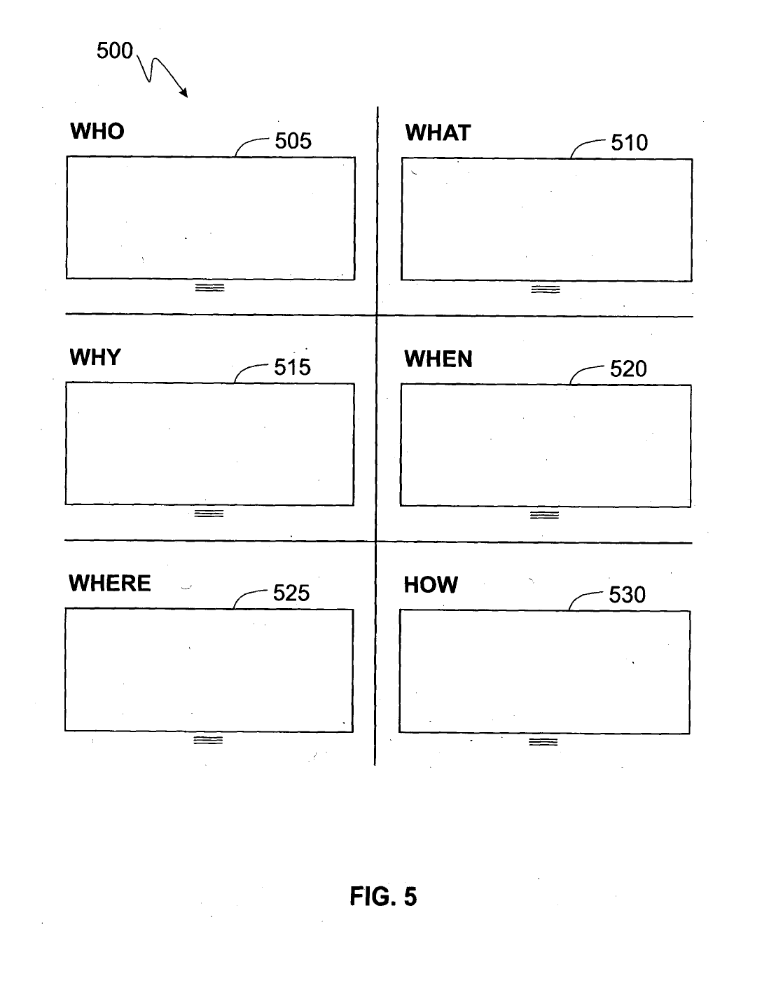

FIG. 5 illustrates a brainstorming component 500 of the pedagogical system 100.

The brainstorming component 500 includes a plurality of predefined topics which are used to assist in the brainstorming. Associated with each predefined topic is a text field, where the user may enter text associated with the predefined topic.

The brainstorming component 500 includes a who text field 505, where a user may enter who the topic of the writing assignment relates to; a what text field 510, where a user may enter what the topic of the writing assignment relates to; a why text field 515, where a user may enter why the topic of the writing assignment is relevant; a when text field 520, where a user may enter to when the topic of the writing assignment may relate or is relevant; a where text field 525, where a user may enter where the topic of the writing assignment is relevant; and a how text field 530, where a user may enter how the topic of the writing assignment is achieved or relates to other topics.

The brainstorming component assists the user in identifying sufficient suitable ideas to answer the essay question prior to starting to write the essay. By brainstorming at this stage, the user can consider all ideas and prioritise these before writing is initiated.

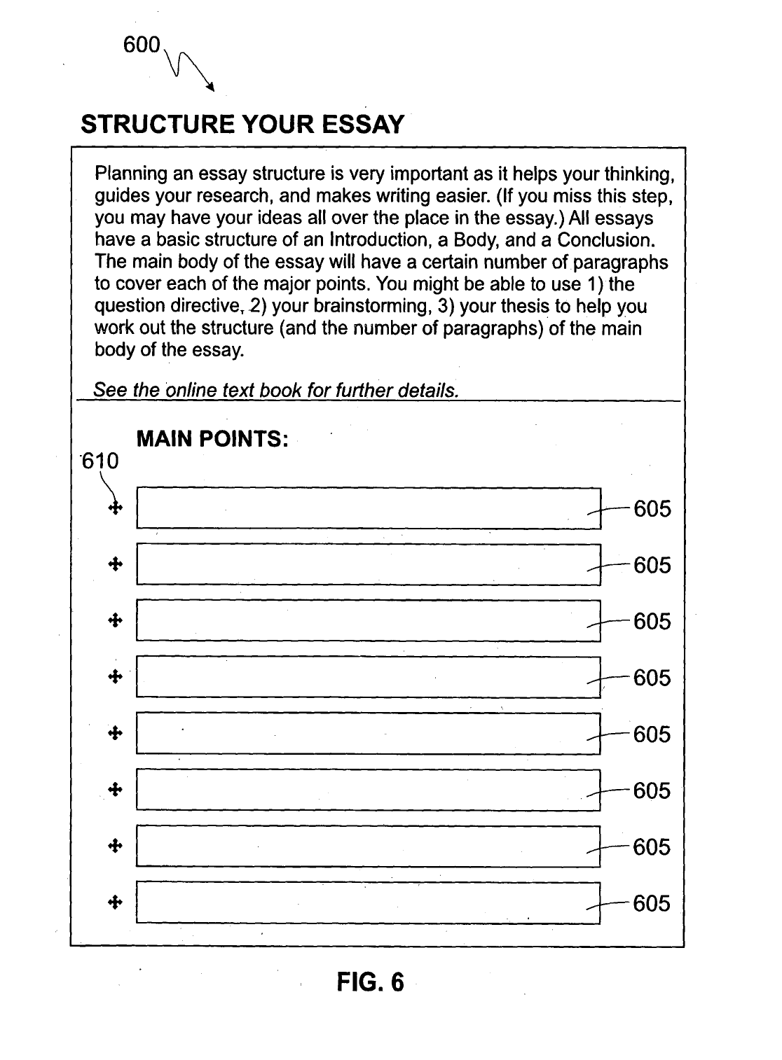

FIG. 6 illustrates a structuring component 600 of the pedagogical system 100, according to an embodiment of the present invention.

The structuring component 600 includes a plurality of main points entry fields 605, where a user may enter main points of the essay. The user may enter any number of main points depending on the topic.

The main points may be re-ordered after they have been entered by clicking on a move button 610 and dragging the main point up or down in the list.

FIG. 7 illustrates an introduction writing component 700 of the pedagogical system 100, according to an embodiment of the present invention.

The introduction writing component 700 includes an opening sentence field 705 and a thesis statement field 710. The introduction paragraph of the essay is then generated by the pedagogical system 100 by concatenating an opening sentence and a thesis statement from the opening sentence field 705 and the thesis statement field 710 respectively.

A similar component is advantageously present to aid in writing the conclusion.

According to an embodiment, the introduction is automatically generated based upon user input. The user input may include an authorisation and purpose, limitations and scope, for example.

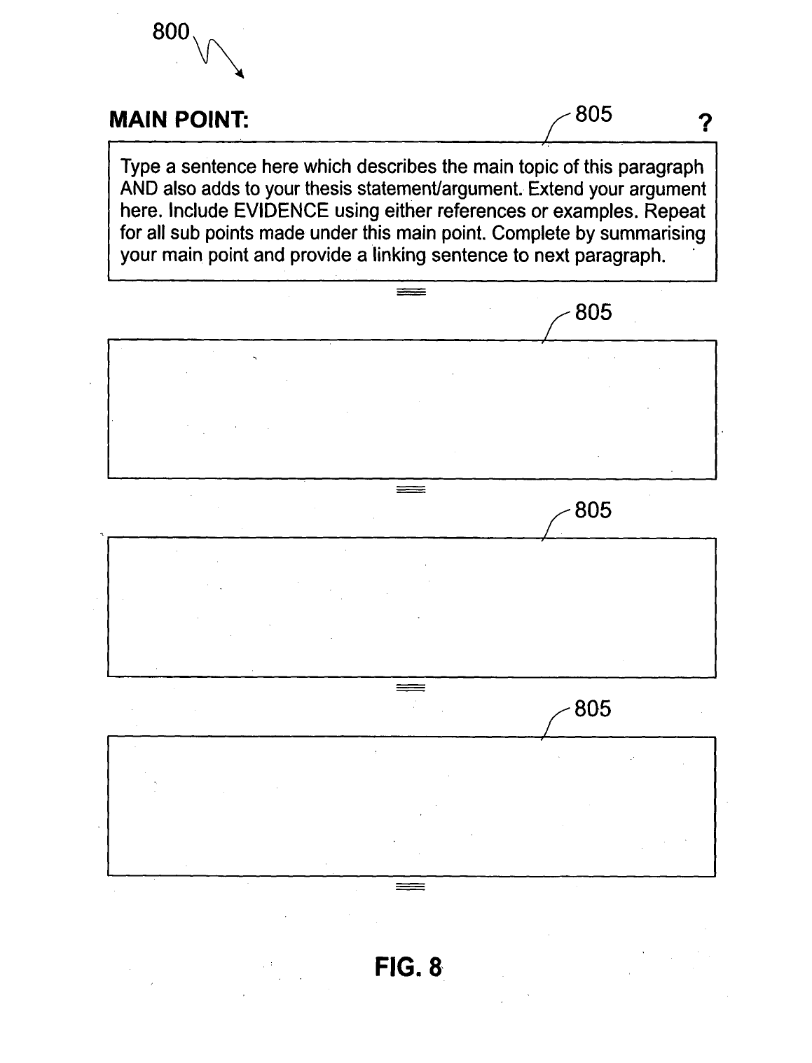

FIG. 8 illustrates a main points writing component 800 of the pedagogical system 100, according to an embodiment of the present invention.

The main points writing component 800 includes a plurality of text entry boxes 805. The pedagogical system 100 generates a text entry box for each of the plurality of main points entered in the structuring component 600 of FIG. 6. The user may add more points by clicking on an add topic button (not shown). Optionally, the user may enter one or more sub-topics for each main point.

The body of the essay or document is then generated by the pedagogical system 100 using the text entered in the text entry boxes 805.

According to an embodiment, numbered headings are automatically generated for each of the main points and/or each of the one or more sub-topics.

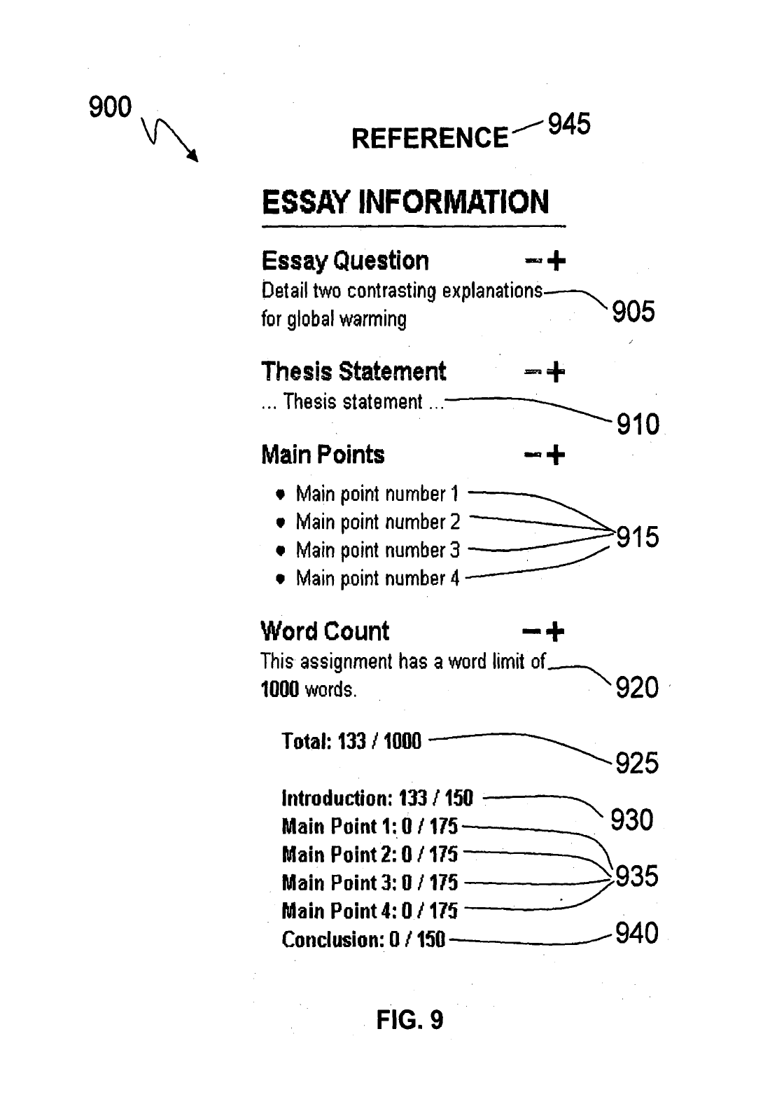

FIG. 9 illustrates an essay information component 900 of the pedagogical system 100, according to an embodiment of the present invention.

The essay information component 900 is shown together with the introduction writing component 700 and main points writing component 800 of FIGS. 7 and 8.

The essay information component 900 includes details of the essay question 905 as provided in the question input field 405, details of the thesis statement 910 as provided in the thesis statement field 710, details of the main points 915 as provided in the main points entry fields 605 and a word count as provided in the number of words field 330.

The essay information component 900 further includes word count data relating to the number of words that have been entered by the user, in comparison with a target number of words.

The pedagogical system 100 assigns a number of words to each section based upon the total number of words provided in the number of words field 330 and the number of sections: Advantageously, a predefined number of words is allocated to the introduction and the conclusion, such as 150 words each. The remaining available words may then be allocated equally between the main points of the essay.

The word count data is automatically updated when a user enters data into the system 100. The word count data includes total word count data 925, introduction word count data 925, main point data 930 for each of the main points, and conclusion word count data 940.

The essay information component further includes an add reference button, which is used to add a reference to text as the text is input, for example in the introduction writing component 700 or main points writing component 800.

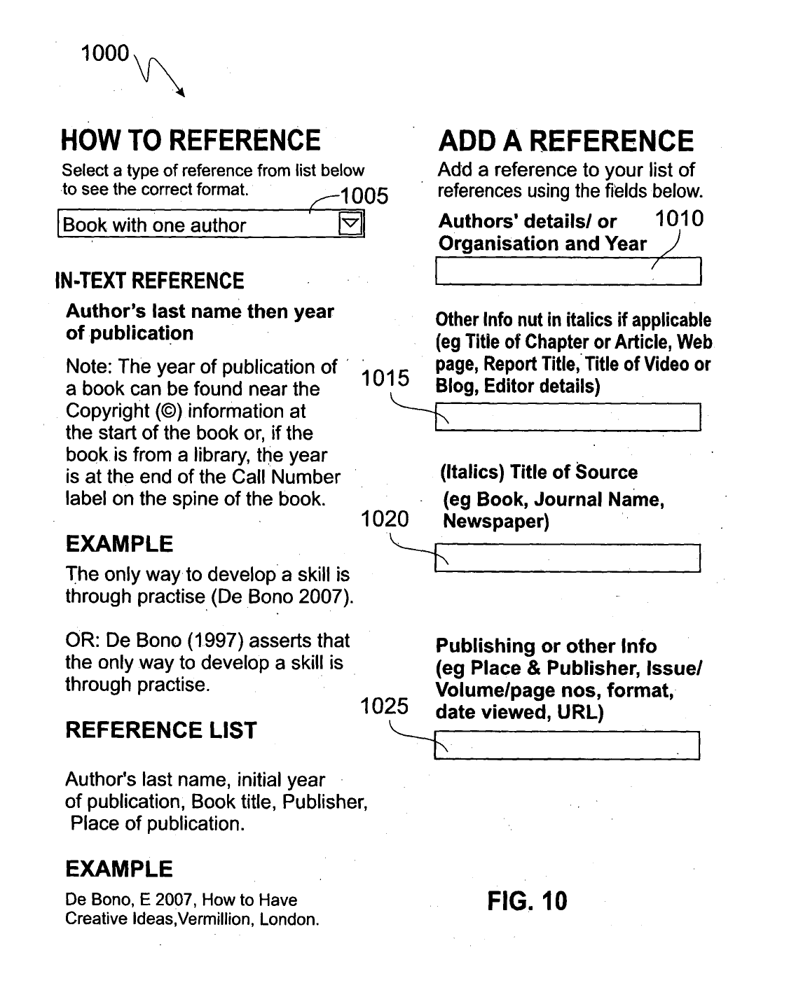

FIG. 10 illustrates a reference component 1000 of the pedagogical system 100, according to an embodiment of the present invention.

The reference component 1000 aids a user in correctly referencing in a number of different formats.

The reference component 1000 includes a reference type selection object 1005, which is used to select the type of reference used from a plurality of reference types. Examples of reference types include a book with one author, a book with two authors, a book chapter, a journal article, and a DVD. Upon selection of a reference type in the reference type selection object 1005, an explanation of how to reference the specific reference type is provided, as is an example of such a reference.

The reference component 1000 further includes an author details data entry field 1010, which is used to enter details of the author of the reference, an other information entry field 1015, for providing a title of a chapter or article, webpage, report title, or similar, a title of source entry field 1020 for entering a title of the source, and a publishing information field 1025 for entering information about the publisher, such as place and publisher, issue or volume.

The data is used to generate a reference which populates the reference list of the essay.

FIG. 11 illustrates an essay completion component 1100 of the pedagogical system 100, according to an embodiment of the present invention.

The essay completion component 1100 includes the essay 1105 as generated by the pedagogical system 100 using the input from the introduction writing component 700 and the main points writing component 800. The essay 1105 may then be reviewed by the user, and mistakes may be corrected.

The essay completion component 1100 additionally includes an editing checklist 1110. The editing checklist includes a plurality of items to check in the essay, such as flow, that there is only one topic per paragraph, etc.

The editing checklist includes a checkbox 1115 for each item in the checklist, assisting the user in keeping track of which items have been checked and which items are remaining.

The essay completion component 1100 additionally includes an ‘email me’ button (not shown) which may be used by the user to send the essay to an email address, either as submission of the essay or for further editing on a computer.

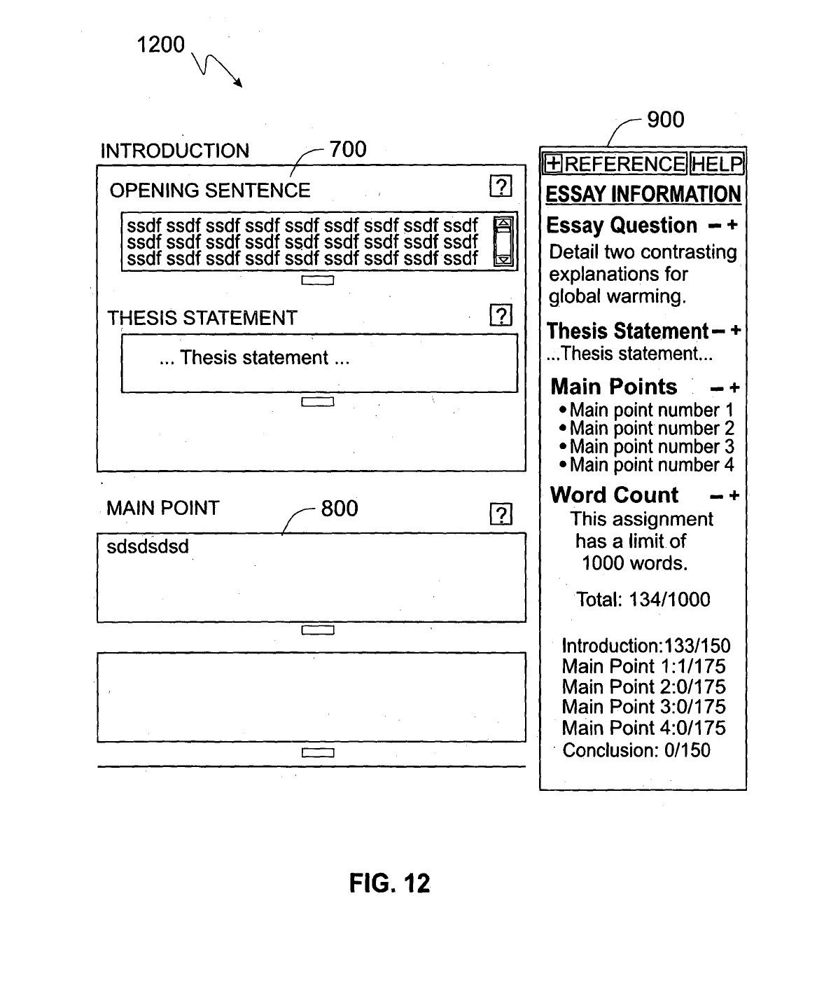

FIG. 12 illustrates a user interface 1200 according to an embodiment of the present invention.

The user interface 1200 includes the introduction writing component 700 of FIG. 7, the main points writing component 800 of FIG. 8 and the essay information component 900 of FIG. 9. The essay information component 900 is advantageously dynamically positioned, such that it is presented in association with an active section of the user interface 1200. For example, if a large number of main points are present, it may not be possible to present the entire main points writing component 800 on a display screen at a single time. By dynamically positioning the essay information component 900, it is possible for a user to scroll down to different sections of the user interface 1200 with the essay information component 900 moving and being presented in association the active section of the user interface.

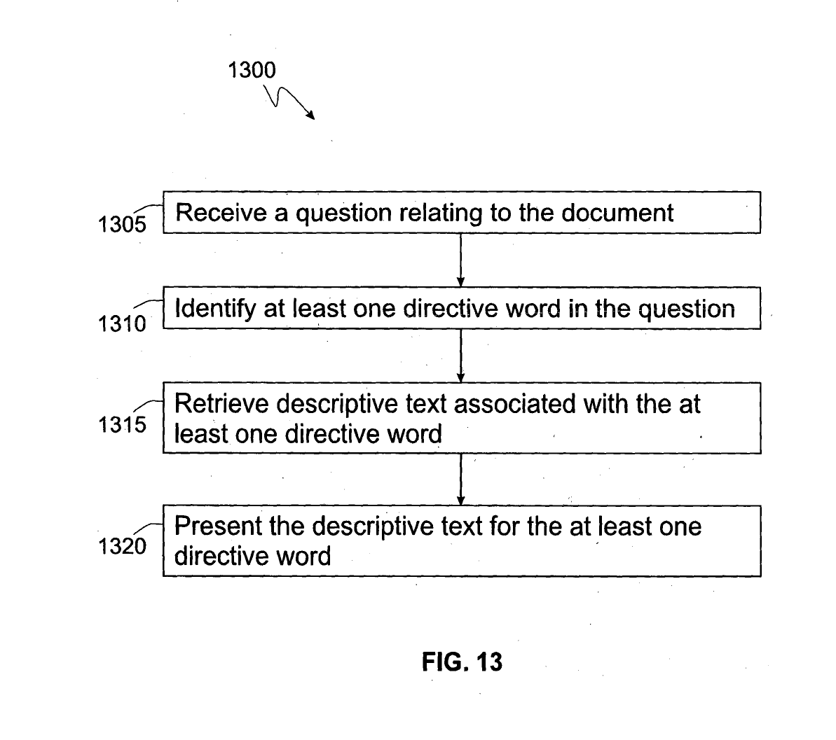

FIG. 13 illustrates a method 1300 for assisting in the generation of a document, according to an embodiment of the present invention.

At step 1305, a question is received relating to the document. The question may be an essay question, as provided by a school, university or other educational institution, or any other question relating to the content of the document.

At step 1310, at least one directive word in the question is identified. Identification of the at least one directive word may include a table look-up, for example.

At step 1315, descriptive text associated with the at least one directive word is retrieved from a data store. The descriptive text may include a definition of the directive word, or a summary of what is typically expected when the directive word is used in the context of an essay question, for example.

At step 1320, the descriptive text for the at least one directive word is presented on a data interface. The presentation on a data interface may comprise a generation of a user interface including the descriptive text.

In summary, advantages of some embodiments of the present invention include an ability to provide an improvement in writing skills while writing a report or document, assistance in breaking a writing task into smaller tasks, assistance in understanding the problem or question of the writing task, assistance in providing strong and convincing arguments and evidence, and improved formalities such as referencing.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A method for assisting in the generation of a document, the method including:
receiving, on a data interface, a question or instruction relating to the document;
identifying, by a computer processor, at least one directive word in the question or instruction;
retrieving, from a data store, descriptive text associated with the at least one directive word;
receiving, on a data interface, a plurality of main points to be addressed in the document;
receiving, on a data interface, a target word count for the document;
assigning, by a computer processor, a target word count for each of the plurality of main points based at least partly on the target word count for the document and the number of main points in the plurality of main points; and
generating, by a computer processor, a user interface including:
a plurality of document generation assistant components, wherein a first component of the plurality of document generation assistant components includes descriptive text for the at least one directive word and a second component of the plurality of document generation assistant components includes the target word counts for each of the plurality of main points; and
an input field for each of the plurality of main points;
wherein, upon presentation of the user interface, the plurality of main points to be addressed is presented in association with text input fields for the plurality of main points, and the second component is presented in association with text input fields for the plurality of main points.

2. The method of claim 1, further comprising:
receiving, on a data interface and via the text input fields for the plurality of main points, text relating to the plurality of main points; and
generating, by a computer processor, at least part of the document based upon the text relating to the plurality of main points.

3. The method of claim 1, further comprising:
receiving, on a data interface and via a text input field for an introduction, text relating to an introduction of the document; and
receiving, on a data interface and via a text input field for a conclusion, text relating to a conclusion of the document; and
generating, by a computer processor, at least part of the document based upon the text relating to the introduction and conclusion of the document;
wherein the user interface includes:
the input field for the introduction; and
the input field for the conclusion.

4. The method of claim 1, further comprising:
receiving, on a data interface and via a text input field, text for the document, wherein the text is associated with a main point of the plurality of main points, the introduction or the conclusion; and
determining, by a processor, a number of words in the text;
wherein, upon presentation of the user interface, the number of words in the text is presented in association with the text input field.

5. The method of claim 1, further comprising:
presenting at least one brainstorming text input field,
wherein, upon presentation of the user interface, the at least one brainstorming text input field is presented before the text input field for each of the plurality of main points.

6. The method of claim 3, wherein the text input field for the introduction includes a thesis statement text input component, and upon presentation of the user interface, any text input in the thesis statement text input component is presented in association with the input fields for the plurality of main points.

7. The method of claim 1, wherein the user interface includes a reference element including:
a reference type selection field;
a plurality of text input fields; and
information relating to referencing;
wherein, upon presentation of the user interface, the information relating to referencing is selected and presented based upon selection in the reference type selection field.

8. The method of claim 1, wherein the user interface comprises a HyperText Markup Language document.

9. A system for assisting in the generation of a document, the system including:
a server including:
a data interface, for receiving a question to be answered in the document;
a data store, including a plurality of directive words and descriptive text associated with each of the directive words;
a processor and memory including program code, for:
identifying directive words in the question;
retrieving, from the data store, descriptive text associated with the directive words; and
an output interface, for displaying the descriptive text for each of the directive words.

10. The system of claim 9, wherein the output interface includes a reference element including:
a reference type selection field;
a plurality of text input fields; and
information relating to referencing;
wherein, upon presentation of the output interface, the information relating to referencing is selected and presented based upon selection in the reference type selection field.

11. The system of claim 9, wherein the output interface comprises a HyperText Markup Language document.

12. The system of claim 9, wherein the memory further includes program code for:
receiving, on the data interface, a plurality of main points to be addressed in the document;
receiving, on the data interface, a target word count for the document; and
assigning, by the processor, a target word count for each of the plurality of main points based at least partly on the target word count for the document and the number of main points in the plurality of main points.

13. The system of claim 12, wherein the memory further includes program code for:
generating, by the computer processor, a user interface including a plurality of document generation assistant components, wherein a first component of the plurality of document generation assistant components includes descriptive text for each word in the plurality of directive words and a second component of the plurality of document generation assistant components includes the target word counts for each of the plurality of main points.

14. The system of claim 12, wherein the memory further includes program code for:
receiving, on the data interface and via text input fields for the plurality of main points, text relating to the plurality of main points; and
generating, by a computer processor, at least part of the document based upon the text relating to the plurality of main points.
